(19) United States
(12) Patent Application Publication
(10) Pub. No.: US 2008/0098218 A1
(43) Pub. Date: Apr. 24, 2008

(54) SECURE COMMUNICATION PROTOCOL AND METHOD THEREFOR

(76) Inventors: James M. Sibigtroth, Round Rock, TX (US); Michael C. Wood, Pflugerville, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/550,518

(22) Filed: Oct. 18, 2006

(51) Int. Cl. H04L 9/00

(52) U.S. Cl. 713/168; 713/179; 713/181

(57) ABSTRACT

A method is provided for secure communication between a transmitter and a receiver. The transmitter comprises a non-volatile memory for storing a first portion of a count value, where the count value is updated after an elapse of a period of time. The transmitter comprises a volatile memory for storing a second portion of the count value. In response to receipt of a transmit request, the transmitter sets a use indicator corresponding to the first portion of the count value. Upon elapse of the period of time, the second portion of the count value is updated. The first portion of the count value is updated if the second portion of the count value overflows and if the use indicator corresponding to the first portion set. A message authentication code is generated based on at least the count value. A message transmitted to the receiver comprises at least the message authentication code.

### RELATED APPLICATION

The present application is related to a commonly assigned, co-pending application by Sibigtroth et al. entitled, “Method and Apparatus For Updating A Count Value”, having attorney docket number TS48143TS, and filed concurrently herewith.

### FIELD OF THE INVENTION

The present invention relates generally to secure communications, and more particularly, to a secure communication protocol and method therefor.

### RELATED ART

Wireless control systems are commonly used to provide remote control of a variety of applications. Certain applications require a level of security. Remote keyless entry (RKE) systems have been designed to allow relatively secure control of automobiles and garage door openers. RKE type systems may also be used in other access entry systems and for device authentication.

Some RKE systems use a rolling code as part of a transmitted security code. The rolling code is combined with a device-unique key code to form an encryption key. In some applications, multiple encryptions are performed on a single received message. A match with one of the encryptions is enough to validate the transmission. However, performing multiple encryptions consumes significantly more power than performing just one encryption per transmission. Also, for security purposes, each rolling code is used only once and then changed to prevent someone with monitoring equipment from capturing a transmitted code and later using it to gain unauthorized access. Each time a rolling code is changed a program operation of a non-volatile memory is required.

Therefore, there is a need for a secure communication system and protocol that consumes less power and uses fewer non-volatile programming operations.

### BRIEF DESCRIPTION OF THE DRAWINGS

The present invention is illustrated by way of example and not limited by the accompanying figures, in which like references indicate similar elements, and in which:

FIG. 1 illustrates, in block diagram form, an RKE transmitter and receiver in accordance with one embodiment.

FIG. 2 illustrates, in block diagram form, the RKE transmitter of FIG. 1 in more detail.

FIG. 3 illustrates a transmitter message in accordance with one embodiment.

FIG. 4 illustrates a method for transmitting a message authentication code (MAC) for use in the transmitter message of FIG. 3.

FIG. 5 illustrates a method for generating the transmitter message of FIG. 3.

FIG. 6 illustrates a method for updating the count portion of the transmitter message of FIG. 3.

FIG. 7 illustrates a method for authenticating the transmitter message of FIG. 3 in an RKE receiver.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE DRAWINGS

As used herein, the term “bus” is used to refer to a plurality of signals or conductors which may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

Generally, there is provided, in one form, a secure communication apparatus and protocol that uses a count value as part of a transmitted message. A lower bit portion is stored in volatile memory and an upper bit portion is stored in non-volatile memory. The count value is incremented based on a time interval that is shorter than a time required to transmit the message. The upper bit portion of the count in non-volatile memory is only programmed with a new count value if the upper bit portion of the count value has been used in a previous transmission.

The transmitted message includes a transmitter number, a command, and a count, none of which are encrypted, and a message authentication code (MAC). Transmitting the count in the clear makes it easier for the receiver to construct the key needed to compute a new MAC to be checked against the received MAC. Some previous protocols needed to generate multiple keys using the expected next count and several additional counts in case some transmitted messages were not received.

Because time is used to increment count values, this could result in numerous updates of the non-volatile portion even when no transmissions are occurring. To avoid unnecessary updates of non-volatile memory, a flag is used to indicate whether the non-volatile portion of the count was ever used in a transmission. If it was not used, there is no need to update the non-volatile memory when the low portion of the count value overflows. The non-volatile portion of the count is also updated after a power interruption to avoid the possibility of reusing a previous count value. If the flag indicates the non-volatile count has not been used in a transmission, it is not necessary to update this count value after a power interruption.

The secure communication apparatus and method may be used in, for example, an RKE system for automobiles and garage door openers. Also, the secure communication apparatus may also be used in other access entry systems and for device authentication. In addition, the secure communication apparatus and method may be used in consumable items such as batteries and toner cartridges.

In one aspect, there is provided, a method for secure communication between a transmitter and a receiver. The transmitter comprises a non-volatile memory for storing a first portion of a count value, where the count value is updated after an elapse of a period of time. The transmitter comprises a volatile memory for storing a second portion of the count value. In response to receipt of a transmit request, the transmitter sets a use indicator corresponding to the first portion of the count value. Upon elapse of the period of time, the second portion of the count value is updated. The first portion of the count value is updated if the second portion of the count value overflows and the use indicator corresponding to the first portion of the count value is set. Based on at least the count value, a message authentication code is generated. A message transmitted to the receiver comprises at least the message authentication code.

In another aspect, there is provided, a method for secure communication between a transmitter and a receiver. A count value is extracted from a message transmitted by the transmitter. The count value has a first portion and a second portion. The second portion of the count value is updated by the transmitter after elapse of a period of time and a first portion of the count value is updated if the second portion of the count value overflows and a use indicator corresponding to the first portion of the count value is set. A learned key segment is retrieved from a receiver memory corresponding to the transmitter if the count value is different from previous count values extracted by the receiver. A message authentication code is generated based on at least the count value retrieved from the receiver memory. The transmitter uses a key comprising at least the count value and the learned key segment. The generated message authentication code is compared to a message authentication code received by the receiver. The message is accepted as a valid message if the generated message authentication code matches the received message authentication code.

FIG. 1 illustrates, in block diagram form, an RKE transmitter 10 and receiver 20 in accordance with one embodiment. Transmitter 10 is coupled to an omni-directional antenna 20, and transmits a message to receiver 24. The message is generated in transmitter 10 in accordance with a protocol 22. In one embodiment, the message includes an authentication portion, a count value, a command, and a transmitter number as will be described in more detail in the discussion of FIG. 3. The message is transmitted to and received by the receiver 24 via antenna 28 (assuming the receiver is within range). The receiver processes the message in accordance with the protocol 26. The message, protocol 22, and protocol 26 include security features that insure no other transmitters except transmitter 10, or another authorized transmitter, can control a device having receiver 24. In the case of an RKE system for an automobile, the security features insure that only the transmitters intended for use with the automobile can have access to the automobile.

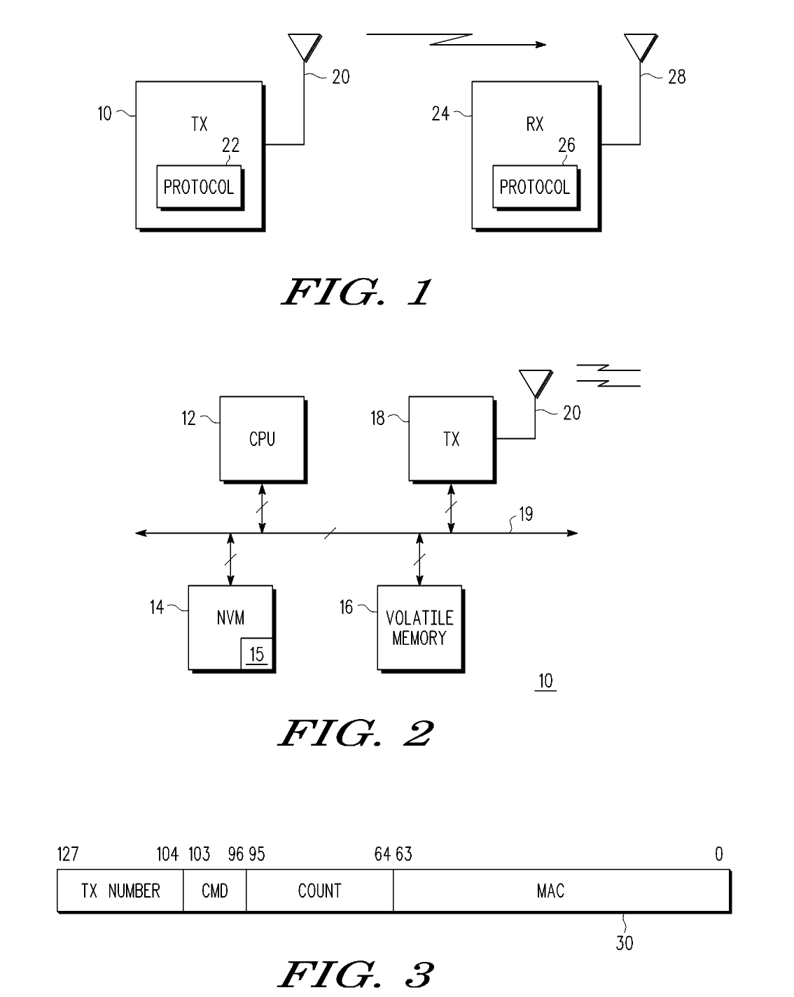

FIG. 2 illustrates, in block diagram form, the transmitter 10 of FIG. 1 in more detail. Transmitter 10 includes a central processing unit (CPU) 12, non-volatile memory (NVM) 14, volatile memory 16, and transmitter portion 18, each bi-directionally coupled to a bus 19. In one embodiment, the protocol 22 of FIG. 1 is implemented in software that is executed on CPU 12. In other embodiments, the protocol 22 may be implemented in software, hardware, or a combination of hardware and software. The protocol 22 may be stored in NVM 14 or may be embodied in combinational logic.

A portion 15 of NVM 14 is for storing a flag value that is for indicating whether or not a count value, stored in NVM 14, has been transmitted or not. The NVM 14 may be implemented with, for example, flash memory, EEPROM (electrically erasable programmable read only memory), MRAM (magneto-resistive random access memory), or other suitable non-volatile memory type. Volatile memory 16 may be any type of volatile memory such as for example, static random access memory (SRAM), dynamic random access memory (DRAM), or the like.

In response to a transmission request signal, a transmitter message is generated in CPU 12 and communicated via bus 19 to transmitter portion 18. The transmission request signal may be generated in response to pushing a button (not shown) in a device having transmitter 10. In the illustrated embodiment, transmitter portion 18 transmits the transmitter message wirelessly via antenna 20. In another embodiment, the transmit request signal may be substituted with a request for device authentication. For example, in a system such as a laptop computer, where the battery contains an authorization tag (analogous to the transmitter in an RKE system), the host laptop would challenge the battery to provide an authentication message or value. The battery (transmitter) would respond with a valid message. In this embodiment, the challenge request is analogous to an RKE button press. Also, the message composition in this embodiment is likely to be different than for an RKE application. In another embodiment, the transmit request signal may be generated by satisfaction of a condition.

FIG. 3 illustrates a transmitter message 30 in accordance with one embodiment. In one embodiment, transmitter message 30 includes 128 bits. In other embodiments, transmitter message 30 may include a different number of bits. As illustrated in FIG. 3, transmitter message 30 includes a message authentication code bit field [0-63] labeled “MAC”, a count value bit field [64-95] labeled “COUNT”, a command bit field [96-103] labeled “CMD”, and a transmitter identification bit field [104-127] labeled “TX NUMBER”.

The MAC bit field is a 64 bit portion of an AES (Advanced Encryption Standard) encryption result which is used to verify that the sender is an authorized transmitter. It is not possible to de-encrypt the MAC to determine the original 128 bit data block. The count value COUNT is a variable code that is 32 bits long and which is transmitted in each transmitter message 30. In the illustrated embodiment, the high 16 bits of the count value are stored in NVM 14 and the 16 low bits are stored in volatile memory 16. The count value COUNT is different for each transmission. In the transmitter, the count value COUNT is a monotonic count which is conditionally updated based on time. In the receiver, the count value COUNT is stored in a non-volatile memory (not shown) related to the transmitter identification TX NUMBER for each valid message that is received. The receiver checks to make sure any new message has a larger count value COUNT than the previous valid message from that transmitter.

The command CMD is an 8 bit field in transmitter message 30 that contains a control command (or data) for use in the application. Example commands in an automotive RKE application include, but are not limited to, lock, unlock, unlock-all, windows down, and start.

The transmitter identification TX NUMBER is a unique 24 bit value that is programmed into each transmitter during manufacturing. The TX NUMBER bit field identifies a specific transmitter.

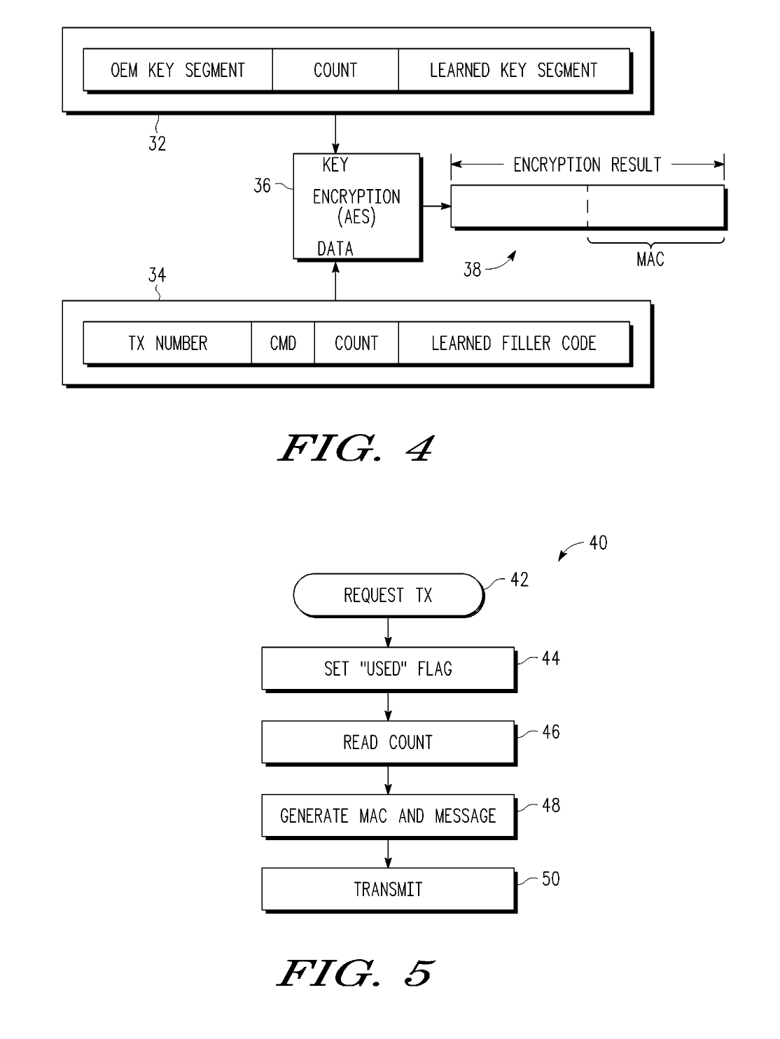

FIG. 4 illustrates a method for generating a MAC for use in the transmitter message MAC bit field of FIG. 3. An encryption block 36 may be implemented in software, as illustrated for example in FIG. 1 and FIG. 2, for implementing the AES encryption algorithm, or it could be dedicated hardware or some combination thereof. Note that in other embodiments, the particular encryption algorithm may be different. Encryption block 36 receives an encryption key 32 at input labeled “KEY”, and encryption data 34 at an input labeled “DATA”. The encryption key 32 includes an OEM (original equipment manufacturer) key segment, a count portion, and a learned key segment as illustrated in FIG. 4. The OEM key segment is a secret 32 bit value that is programmed into every transmitter and receiver in a group of compatible devices. This value is stored in a secured portion of NVM memory 14 and is not transmitted so it is known only to the OEM. The COUNT bit field includes the count value as transmitted in transmitter message 30. The learned key segment bit field of encryption key 32 is a secret 64 bit value which is generated in the transmitter and memorized by the receiver during learning. This value is different each time the learning procedure is repeated. The “learning” procedure is used during manufacturing and any time a transmitter is introduced to a receiver to match certain values in the transmitter to corresponding values in the receiver.

The encryption data 34 includes the transmitter number TX NUMBER, command CMD, count value COUNT, and learned filler code “LEARNED FILLER CODE”. The bit fields TX NUMBER, CMD, and COUNT are the same as described in the discussion of FIG. 3. The bit field LEARNED FILLER CODE includes a secret 64 bit value which is generated in the transmitter and memorized by the receiver during learning. This value is different each time the learning procedure is repeated.

Using the encryption key 32 and the encryption data 34, the encryption block 36 produces an encryption result 38. In the illustrated embodiment, the encryption result is truncated such that the 64 least significant bits are used as the MAC portion of the transmitter message. In other embodiments, a different portion of the encryption result 38 can be used as the MAC portion.

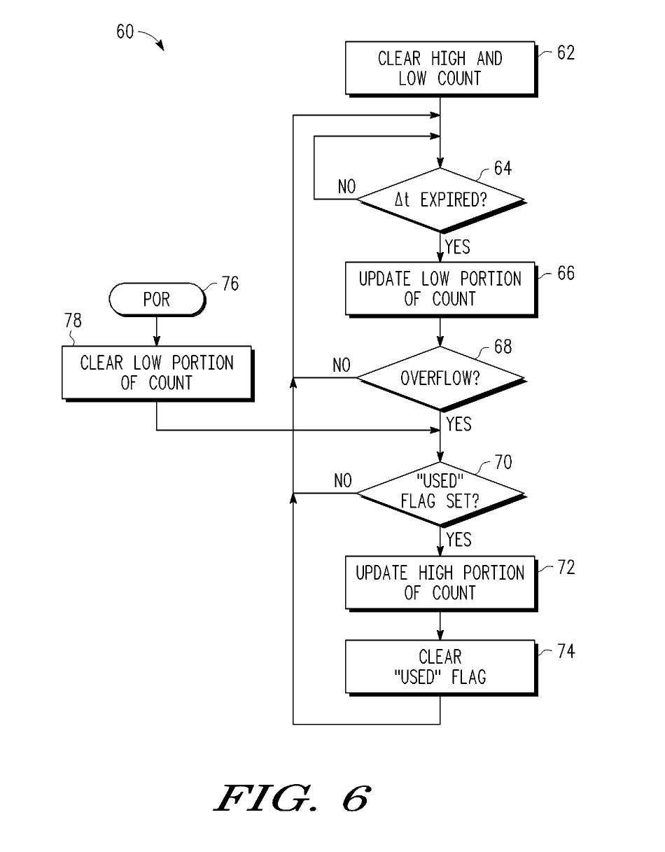

FIG. 5 illustrates a method 40 for transmitting the transmitter message 30 of FIG. 3. In method 40, at step 42, a request is generated in the transmitter to send a message 30. The request may be generated by pushing a button (not shown). At step 44, a USED flag bit is set in portion 15 of NVM 14 to indicate that the count value COUNT has been used. The count value COUNT will be updated as described in the discussion of FIG. 6, below. At step 46, the count value COUNT is read from NVM 14. At step 48, a MAC is generated as described above regarding FIG. 4. The MAC is included in the MAC bit field of message 30 as illustrated in FIG. 3. At step 50, message 30 is transmitted to a receiver.

FIG. 6 illustrates a method 60 for updating the count portion of the transmitter message of FIG. 3. In method 60, at step 62, both the high bit portion and the low bit portion of the count value COUNT are cleared. As discussed above, the high portion is the 16 most significant bits and the low portion is the 16 least significant bits. The high portion is stored in NVM 14 and the low portion is stored in volatile memory 16. At decision step 64, it is determined if a time period Δt has expired. In the illustrated embodiment, Δt is about one second, in other embodiments, Δt is any period less than a time it takes to transmit a new message 30. If Δt has not expired, then the NO path is taken back to the entry into step 64. When Δt expires, the YES path is taken to step 66. At step 66, the lower 16 bit portion of count value COUNT is updated. In the illustrated embodiment, the low portion is updated by incrementing the count value COUNT by one. In other embodiments, the count value COUNT may be updated by incrementing or decrementing by any number. At decision step 68, it is determined if a memory portion for storing the low portion has overflowed. If the low portion has not overflowed, the NO path is taken back to step 64. If the low portion has overflowed, or exceeded its maximum value, the YES path is taken to decision step 70. At decision step 70 it is determined if the flag in portion 15 (FIG. 2) has been set to indicate that the count value COUNT currently stored in memory has already been used at least once. If the count value has not been used, or transmitted, then it is not necessary to update the count value and the method continues at step 64. However, if the “USED” flag has been set, indicating that the count value COUNT has been transmitted already, then the YES path is taken to step 72. At step 72, the high portion of count value COUNT is updated by incrementing. In other embodiments, the high portion of COUNT may be updated in some other way. At step 74, the “USED” flag is cleared.

If power is removed from the transmitter 10, for example, when exhausted batteries are replaced, then a power-on-reset (POR) operation is run by the CPU 12. In method 60, at step 76, a POR event causes a POR operation to run. At step 78, the low portion is cleared to maximize the length of time until the next NVM update. After step 78 the method continues at step 70.

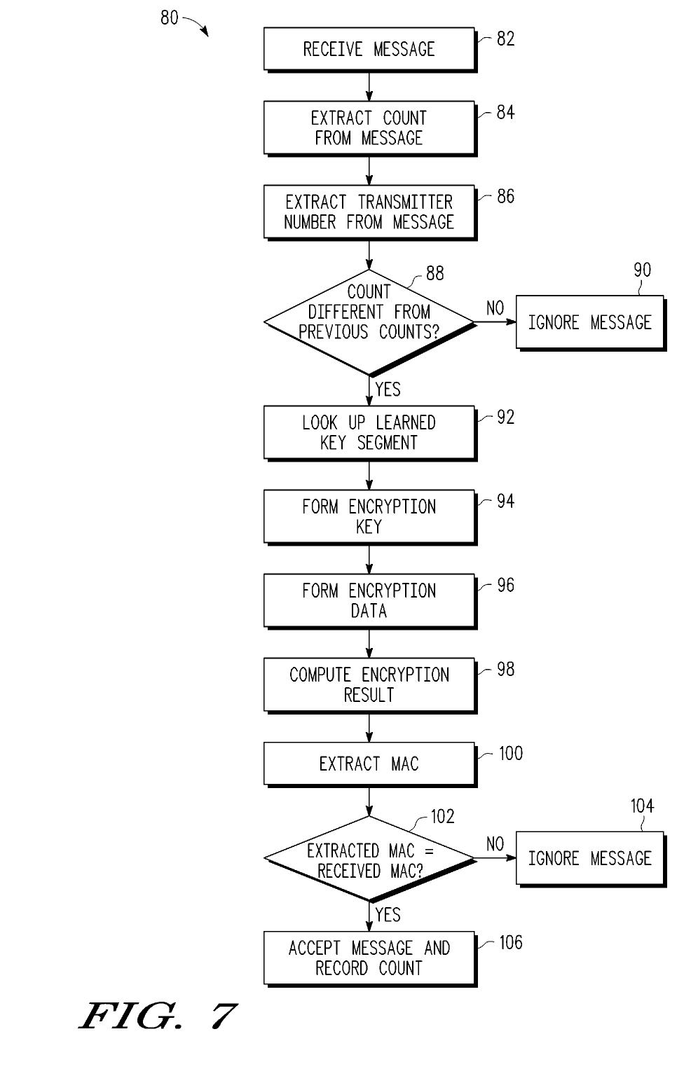

FIG. 7 illustrates a method 80 for authenticating transmitter message 30 of FIG. 3 in an RKE receiver. At step 82, the message 30 is received by receiver 24 (FIG. 1). At step 84, the count value COUNT is extracted from message 30. At step 86, the transmitter identifier TX NUMBER is extracted from message 30. At decision step 88, it is determined if the count value COUNT is different from all previously used count values. If the count value COUNT is the same as a previously used count value, then the message 30 is ignored as being invalid. If the count value COUNT is not the same as a previously used count value, then the YES path is taken to step 92. At this point the receiver needs to generate a MAC as described above regarding FIG. 4. At step 92, the learned key segment (FIG. 4) of the encryption key 32 is retrieved from a look-up table stored in NVM 14. At step 94, the encryption key 32 is formed as described in the discussion of FIG. 4. At step 96, the encryption data 34 is formed. At step 98, the encryption result 38 is computed. At step 100, the MAC is extracted from the encryption result 38 computed at step 98. At decision step 102, it is determined if the extracted MAC is the same as the MAC received in the message 30. If the extracted MAC is not equal to the received MAC, the NO path is taken to step 104 and the message is ignored as not being a valid message from an authorized transmitter. If the extracted MAC is equal to the received MAC, then the YES path is taken to step 106 and the message 30 is accepted and the count value COUNT is updated as described in the discussion of steps 72 and 74 of FIG. 6.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. The terms a or an, as used herein, are defined as one or more than one. The terms including and/or having, as used herein, are defined as comprising (i.e., open language). As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for secure communication between a transmitter and a receiver, wherein the transmitter comprises a non-volatile memory for storing a first portion of a count value, wherein the count value is updated after an elapse of a period of time, and wherein the transmitter comprises a volatile memory for storing a second portion of the count value, the method comprising:
in response to receipt of a transmit request, the transmitter setting a use indicator corresponding to the first portion of the count value and reading the count value, wherein updating the count value comprises:
upon elapse of the period of time, updating the second portion of the count value, and
updating the first portion of the count value if the second portion of the count value overflowed and the use indicator corresponding to the first portion of the count value is set; and
based on at least the count value, generating a message authentication code and transmitting a message to the receiver, the message comprising at least the message authentication code.

2. The method of claim 1, wherein generating the message authentication code comprises encrypting a data block comprising a transmitter number, a command for initiating at least one action, and the count value using a key comprising a key segment, the count value, and a learned key segment.

3. The method of claim 2, wherein generating the message authentication code further comprises truncating an encryption result of the encrypting step to generate a truncated portion of the encryption result.

4. The method of claim 3, wherein the message authentication code comprises the truncated portion of the encryption result.

5. The method of claim 1, wherein the transmit request is based on at least one of:
a button press by a user of the transmitter;
a request for authorization from a host device; and
a satisfaction of a condition.

6. The method of claim 2 further comprising clearing the use indicator after updating the first portion of the count value.

7. The method of claim 1 further comprising;
upon detecting a power on reset event, clearing the second portion of the count value; and
updating the first portion of the count value if the use indicator corresponding to the first portion of the count value is set.

8. The method of claim 1, wherein the transmitter comprises at least a part of a remote keyless entry transmitter and the receiver comprises at least a part of a remote keyless entry receiver.

9. The method of claim 1, wherein the transmitter comprises at least a part of a secure-area access key transmitter and the receiver comprises at least a part of a secure-area access key receiver.

10. The method of claim 1, wherein the transmitter comprises at least a part of a consumable item and the receiver comprises at least a part of an apparatus for receiving the consumable item.

11. The method of claim 10, wherein the consumable item is a toner cartridge and the apparatus is configured to receive the toner cartridge.

12. The method of claim 10, wherein the consumable item is a battery and the apparatus is configured to receive the battery.

13. The method of claim 1, wherein the transmitter is a wireless transmitter and the receiver is a wireless receiver, such that the wireless transmitter and the wireless receiver can communicate over an air interface using radio frequency waves.

14. The method of claim 2, wherein the learned key segment is generated by the transmitter and is stored by the receiver in its memory as part of a learning process, and wherein the learned key segment is different each time the learning process is performed.

15. The method of claim 1, wherein the first portion corresponds to higher significant bits of the count value and the second portion corresponds to lower significant bits of the count value.

16. A method for secure communication between a transmitter and a receiver, the method comprising:
extracting a count value from a message transmitted by the transmitter, wherein the count value has a first portion and a second portion, wherein the second portion of the count value is updated by the transmitter after elapse of a period of time and a first portion of the count value is updated if the second portion of the count value overflows and a use indicator corresponding to the first portion of the count value is set by the transmitter;
retrieving a learned key segment stored in a receiver memory corresponding to the transmitter if the count value is different from previous count values extracted by the receiver;
generating a message authentication code based on at least the count value retrieved from the receiver memory corresponding to the transmitter using a key comprising at least the count value and the learned key segment;
comparing the generated message authentication code to a message authentication code received by the receiver; and
accepting the message as a valid message if the generated message authentication code matches the received message authentication code.

17. The method of claim 16, wherein the transmitter comprises at least a part of a remote keyless entry transmitter and the receiver comprises at least a part of a remote keyless entry receiver.

18. The method of claim 16, wherein the transmitter comprises at least a part of a secure-area access key transmitter and the receiver comprises at least a part of a secure-area access key receiver.

19. The method of claim 18, wherein the transmitter comprises at least a part of a consumable item and the receiver comprises at least a part of an apparatus for receiving the consumable item.

20. The method of claim 19, wherein the consumable item is a toner cartridge and the apparatus is configured to receive the toner cartridge.

21. The method of claim 19, wherein the consumable item is a battery and the apparatus is configured to receive the battery.

22. The method of claim 16, wherein the transmitter is a wireless transmitter and the receiver is a wireless receiver, such that the wireless transmitter and the wireless receiver can communicate over an air interface using radio frequency waves.

23. The method of claim 16, wherein the first portion corresponds to higher significant bits of the count value and the second portion corresponds to lower significant bits of the count value.
